(19) United States
(12) Patent Application Publication
(10) Pub. No.: US 2025/0209485 A1
(43) Pub. Date: Jun. 26, 2025

(54) PROPERTY REVENUE MANAGEMENT

(71) Applicants: Robert CONSALVO, Winter Garden, FL (US); Christopher Thomas HARRIS, Winter Garden, FL (US); Stephen SANDECKI, Greenwood Village, CO (US); Eric SCHMIEDEL, Greenwood Village, CO (US)

(72) Inventors: Robert CONSALVO, Winter Garden, FL (US); Christopher Thomas HARRIS, Winter Garden, FL (US); Stephen SANDECKI, Greenwood Village, CO (US); Eric SCHMIEDEL, Greenwood Village, CO (US)

(21) Appl. No.: 18/866,396

(22) PCT Filed: May 15, 2023
(86) PCT No.: PCT/US2023/022258

§ 371 Date: Nov. 15, 2024

Related U.S. Application Data
(60) Provisional application No. 63/342,295, filed on May 16, 2022.

(51) Int. Cl. G06Q 30/0201; G06Q 10/0639; G06Q 50/163

(52) U.S. Cl. CPC G06Q 30/0206; G06Q 10/06393; G06Q 50/163

(57) ABSTRACT

Methods and systems described herein are directed to generating automated pricing reports for individual units based on rule definitions to optimize revenues. The rule definitions can be used to organize units into groups where each group represents a strategy for the units at a facility that are part of the group. For example, the rules can consider available units, occupancy percentage, unit location, unit size, or similar unit information when organizing units into groups. The property revenue management system can execute a process periodically (e.g., hourly, daily, weekly, monthly, etc.) that analyses each unit at every facility in a group to determine a pricing suggestion for each unit. The property management system can provide the pricing suggestion in a report to a user for review.

### CROSS-REFERENCE TO RELATED APPLICATIONS

This application is a U.S. National Stage Application of International Application No. PCT/US2023/022258 filed on May 15, 2023, which claims priority to U.S. Provisional Patent Application No. 63/342,295, filed on May 16, 2022, both of which are incorporated herein by reference in their entireties.

### BACKGROUND

A property manager can oversee hundreds of units, such as apartments, storage units, or rental properties, at any given time. Throughout the year, as the units become vacant or damaged, the property manager will need to adjust pricing of the units to remain competitive in the market and still attract tenants. However, when overseeing hundreds or thousands of units at various locations, property managers can become unaware of competitive pricing for each unit.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for defining rules and groups in a property revenue management system.

FIG. 5 is a flow diagram illustrating a process used in some implementations for generating a price in a property revenue management system.

FIG. 6 is a flow diagram illustrating a process used in some implementations for modifying a rate in a property revenue management system.

FIG. 7 is a flow diagram illustrating a process used in some implementations for modifying a rate in a property revenue management system.

FIG. 8 is a conceptual diagram illustrating an example of a property revenue management system.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to managing property revenue by generating pricing reports for individual unit types based on metrics. Currently, property managers have to manually create a price for each unit (e.g., apartments, storage units, houses, condo, buildings, rental property, rental equipment, etc.) which generally includes adjusting the fee associated with the unit by an amount each year or for peak seasons. However, property managers are unable to determine if the price for each unit is competitive in the market or if the price is the correct amount to attract tenants. Thus, a property revenue management system is needed to continuously provide a property manager with updated pricing for each unit in a facility.

The property revenue management system described herein can generate automated pricing reports for individual units based on rule definitions to optimize revenues. In certain aspects, the property revenue management system provides an automated tool used to optimize revenue, that users can use to craft formulas and use external data points to generate suggested pricing through machine learning technology and operator specific metrics. In certain aspects, the technology provides an automated tool used to optimize revenue, that users can use to craft formulas (or rules) and use external data points to generate suggested pricing through machine learning technology and operator specific metrics. The rule definitions can be used to organize units into groups where each group represents a strategy for the units that are part of the group. For example, the rules can consider available units, occupancy percentage, unit location, unit size, or similar unit information when organizing units into groups. The property revenue management system can execute a process periodically (e.g., hourly, daily, weekly, monthly, etc.) that analyses each unit at every facility in a group to determine a pricing suggestion for each unit. The property management system can provide the pricing suggestion in a report to a user for review.

Methods and systems disclosed herein can provide technical advantages over conventional property management system. Conventional property management systems, for example, are unwieldly and impossible for a person to monitor over hundreds of properties over differing geographical regions, which may be towns, cities, states or countries. The property revenue management system described herein can dynamically provide rates for units based on a set of rules for each group of units to allow a central manager the ability to manage pricing over the differing geographical regions. For example, the property revenue management system can provide one or more of the following technological improvements: 1) dynamic pricing for units; 2) automated process of updating thousands of rates while reducing the risk of costly errors; and 3) provides an interface for users to quickly and efficiently manage both asking and in-place rates.

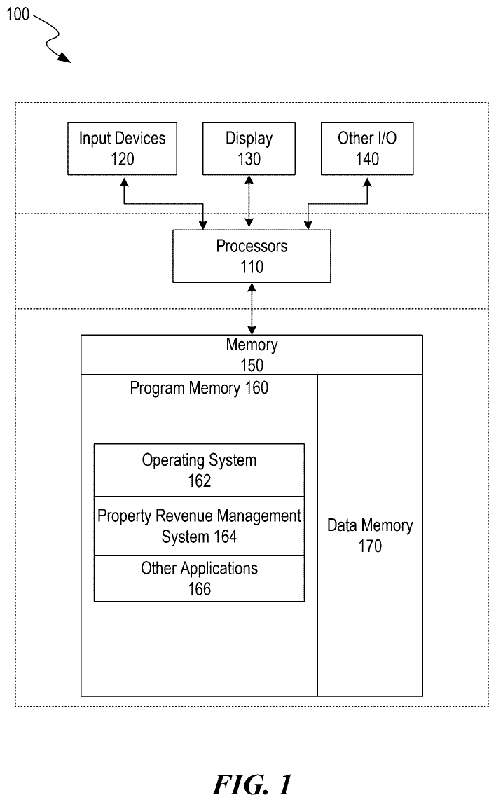

Several implementations are discussed below in more detail in reference to the figures. FIG. 1 is a block diagram illustrating an overview of devices on which some implementations of the disclosed technology can operate. The devices can comprise hardware components of a device 100 that execute customized queries created from user selections, of query elements, that are based on meta-data from data set registrations. Device 100 can include one or more input devices 120 that provide input to the Processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user.

In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, property revenue management system 164, and other application programs 166. Memory 150 can also include data memory 170, e.g., revenue data, tenant data, unit data, user interface data, facility data, rate data, location data, rental data, ledger data, price suggestion data, report data, call tracking data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

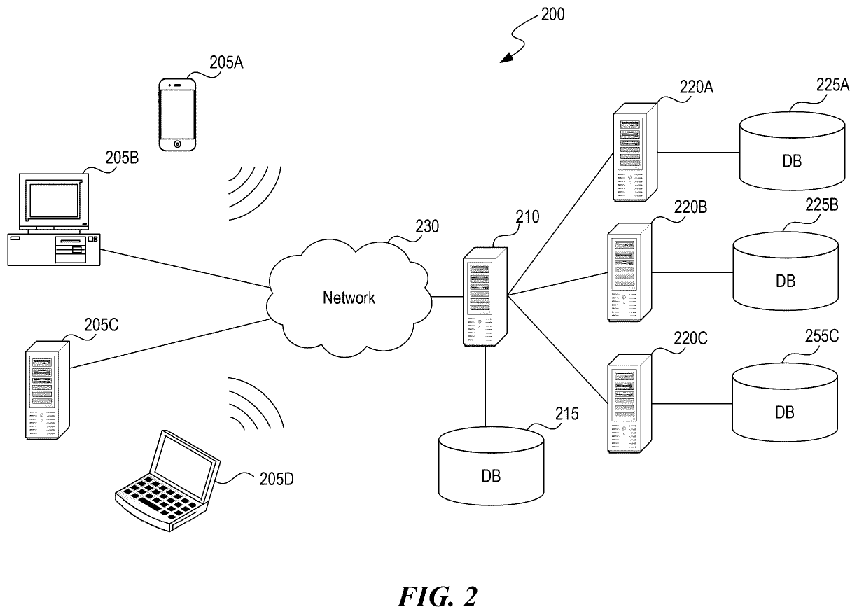

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as revenue data, tenant data, unit data, user interface data, facility data, rate data, location data, rental data, ledger data, price suggestion data, report data, call tracking data, settings, user options or preferences. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

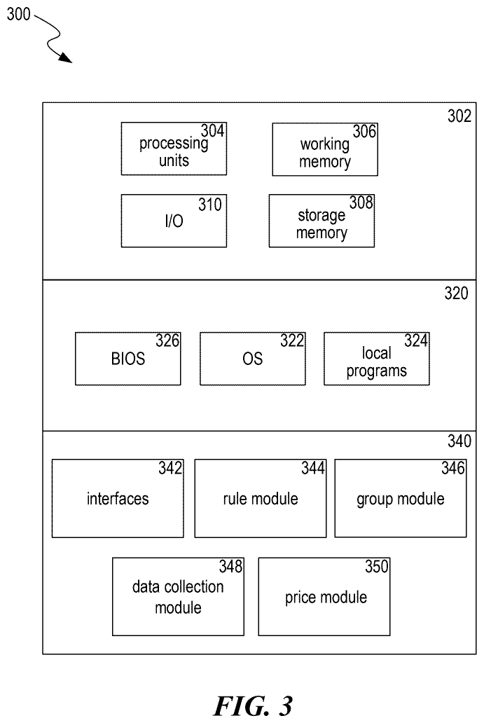

FIG. 3 is a block diagram illustrating components 300 which, in some implementations, can be used in a system employing the disclosed technology. The components 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). Components 300 can be implemented in a client computing device such as client computing devices 205 or on a server computing device, such as server computing device 210 or 220.

General software 320 can include various applications including an operating system 322, local programs 324, and a basic input output system (BIOS) 326. Specialized components 340 can be subcomponents of a general software application 320, such as local programs 324. Specialized components 340 can include rule module 344, group module 346, data collection module 348, and price module 350, and components which can be used for providing user interfaces, transferring data, and controlling the specialized components, such as interfaces 342. some implementations, components 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

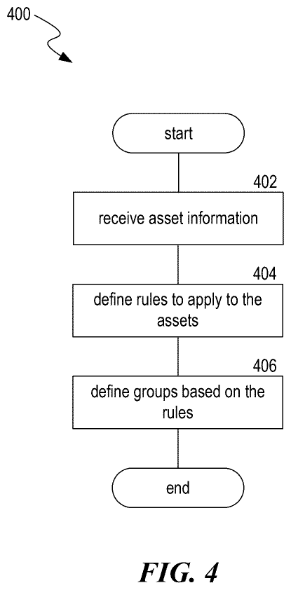

In some implementations, the rule module 344 is configured to define rules that are applied to asset (units). The rule module 344 can provide the property revenue management system with a process or filter to generate prices for the unit types that belong to the group's facilities. The rules for a group can be made up of “if/then” statements that allow the user to define “if” conditions and apply a “then” outcome if the unit type meets all of the “if” conditions. Additional details on rules are provided below in relation to FIG. 4.

In some implementations, the group module 346 is configured to organize units into groups based on a set of rules. The group module 346 can organize the units that have the same or similar rules applied to each unit type. A group can consist of a name (e.g.: ‘College Lease Up’ or ‘Urban Revenue Maintenance’), a description, the units that make up the group, and the rules that will be used to determine individual unit type pricing for that group. Each group represents a strategy for the facilities that have units in the group. Additional details on groups are provided below in relation to FIG. 4.

In some implementations, the data collection module 348 is configured to collect asset information about assets at a property. The asset information can include the facility location, location code, unit size, unit type, unit area, unit square footage, floor level, total number of units per building, number of vacant units, number of unrentable units, number of move-ins, number of move-outs, net move-ins, number of days the tenant has been at a current rate, the occupancy percentage, standard rate dollar variance, standard rate percentage variance, current promotion, standard rate for each unit, lowest in-place rate, average in-place rate, maximum in-place rate, days to fill, fill rate, or time since last rental. The data collection module 348 can collect the asset information from user interfaces, APIs, website scraping, retrieving the information from a database, user accounts or user devices, or user provided information.

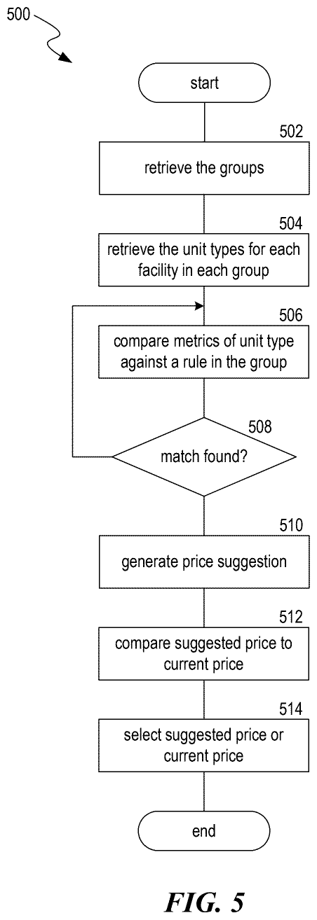

In some implementations, the price module 350 is configured to generate a pricing report for a group of units or for each individual unit. The price module 350 can use competitor minimum, average and maximum pricing, which is determined based upon collection of competitor rates. The price module may group the competitor units into groups, such as small, medium, and large units based on for example, square feet (sf). For example, the grouping of these rates may be into small (0-80sf), medium (81-180sf) and large (>180sf) buckets for the purposes of determining an average rent per square foot for each bucket in the local market. The price module 350 can analyze each unit type at every facility in a group, determine what the prices should be based on the rule definition, and report the determined prices team to the property revenue management system. Additional details on pricing are provided below in relation to FIGS. 5-8.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for defining rules and groups in a property revenue management system. In some implementations, process 400 can be initiated by a user accessing an interface to register property assets, a user requesting revenue information, or changes in the status of the property assets. Thus, process 400 can be a device side process or a server-side process for a system that defines rules and groups for property management.

At block 402, process 400 can receive asset information (or data) about a property in the property revenue management system. The asset information can include the facility location, location code, unit size, unit type, unit environmental controls, unit area, unit square footage, floor level, total number of units per building, number of occupants in a unit, number of occupied units, number of vacant units, number of unrentable units, number of move-ins, number of move-outs, net move-ins, number of days the tenant has been at a current rate, the occupancy percentage, standard rate dollar variance, standard rate percentage variance, current promotion, standard rate for each unit, lowest in-place rate, average in-place rate, maximum in-place rate, days to fill, fill rate, or time since last rental.

At block 404, process 400 can define rules to organize the assets. Process 400 can provide the automated pricing suggestions based on predetermined or user-defined rules. The rules indicate metrics on how to determine prices for the unit types that belong to the group's facilities. In certain aspects, an automated tool used to optimize revenue, that users can use to craft formulas and use external data points to generate suggested pricing through machine learning technology and operator specific metrics.

At block 406, process 400 can group assets based on the rules. The purpose of a group is to organize assets/units that have similar rules for each unit types. A group consists of a name (e.g., ‘College Lease Up’ or ‘Urban Revenue Maintenance’), a description, the units that make up the group, and the rules that will be used to determine individual unit type pricing for that group. These rules are attached to groups where each group represents a strategy for the facilities that are part of the group. A process 400 can collect asset information and organize the units periodically (e.g., hourly, daily, weekly, monthly, etc.) to analyze each unit type at every facility in a group, determine what the price should be based on the rule definition, and report all price suggestions to the revenue management team. The rules for a group are made up of “if/then” statements that allow the user to define “if” conditions and apply a “then” outcome if the unit type meets all of the “if” conditions. The “if” condition follows the form of a metric, a direction, an optional logical operator, and a value. Examples of metrics can include available units, occupancy percentage and net rentals in an amount of time (e.g., net rentals in the last 30 days). Examples of directions for an individual metric include less than, less than or equal to, equal to, greater than or equal to, or greater than. Examples of logical operators include “and” and “or.”

After the “if” conditions have been set, the user is can select a desired “then” outcome. The “then” outcome is what the price can be set to if the unit type matches the “if” conditions. The outcome can include an outcome operator, and one or two outcome factors (depending on the selected outcome operator). Examples of outcome operators include equal to, lesser of, greater of, and midpoint. Examples of outcome factors include market rate low, market rate average, market rate high, in-place rate low, in-place rate average, and in-place rate high. Examples of rules with each individual portion of the rule indicated are: 1) if ‘occupancy percentage (metric)’ is ‘greater than (direction) 90%, and (logical operator)’ ‘available units (metric)” is ‘less than (direction)’ 5, then set standard rate to ‘greater of (outcome operator)’ ‘market rate high (outcome factor)’ or ‘in-place rate high (outcome factor); 2) if ‘occupancy percentage (metric)’ is ‘less than or equals (direction) 89% ‘and (logical operator)’ ‘net rentals last 30 days’ is ‘greater than 3, then set standard rate ‘equal to (outcome operator)’ ‘in-place rate average (outcome factor); 3) if ‘occupancy percentage (metric)’ is ‘less than or equals (direction) 89% ‘and (logical operator)’ ‘net rentals last 30 days (metric)’ is ‘less than (direction)’ 2 ‘or (logical operator)’ ‘available units (metric)’ is ‘greater than (direction)’ 5, then set standard rate to ‘lesser of (outcome operator)’ ‘market rate low (outcome factor)’ or ‘in-place rate low (outcome factor) “.

Examples of rule definitions include: 1) If “Available Units” is equal to 0 (zero), then set the standard rate to the greater of the “Market Rate High” or “In-Place Rate High”; 2) if “Occupancy Percentage” is less than 80% and “Net Rentals Last 30 Days” is greater than 0 (zero), then set the standard rate to “Market Rate Average”; 3) if “Occupancy Percentage” is less than 80% and “Net Rentals Last 30 Days” is less than or equal to 0 (zero), then set the standard rate to the “Market Rate Low”; 4) if “Occupancy Percentage” is greater than or equal to 80% and “Occupancy Percentage” is less than 89% and “Net Rentals Last 30 Days” is greater than 0 (zero), then set the standard rate to the midpoint of “Market Rate Average” and “Market Rate High”; 5) if “Occupancy Percentage” is greater than or equal to 80% and “Occupancy Percentage” is less than 89% and “Net Rentals Last 30 Days” is less than 0 (zero), then set the standard rate to the midpoint of “Market Rate Average” and “Market Rate Low”; 6) if “Occupancy Percentage” is greater than or equal to 89%, or “Available Units” is less than 4, and “Net Rentals Last 30 Days” is greater than or equal to 0 (zero), then set the standard rate to the greater of “Market Rate High” or “In-Place Rate High”; and 7) if “Occupancy Percentage” is greater than or equal to 89%, or “Available Units” is less than 4, and “Net Rentals Last 30 Days” is less than 0 (zero), then set the standard rate to “Market Rate High”.

FIG. 5 is a flow diagram illustrating a process used in some implementations for generating a price in a property revenue management system. In some implementations, process 500 can be initiated by a user accessing an interface to register property assets, a user requesting revenue information, changes in the status of the property assets, a request for a pricing report, or periodically generated pricing report. Thus, process 500 can be a device side process or a server-side process for a system that generates pricing reports.

Process 500 can generate pricing reports when at least one group exists with at least one rule defined for that group. In some implementations, process 500 can automatically generate and send a report periodically (e.g., daily, weekly, etc.) to a user (e.g., email address, text, IM, etc.). In some implementations, process 500 can generate a price change set that can be created from a price suggestion report. At block 502, process 500 can retrieve the groups at a facility or in the property management system. At block 504, process 500 can retrieve for each group all unit types for each facility in the group. At block 506, process 500 can compare the metrics for each unit type against the first rule in the group. At block 508, if a match is found, process 500 can provide the price in the “then” (outcome) section of the rule. If the provided price is the same as the unit type's current price, then the unit type is skipped. At block 508, if a match is not found, process 500 can compare the unit type to the next rule in the group. Process 500 can perform the comparison until no more rules exist within the group. If a match cannot be found against any rule in the group, then no price is suggested, and the unit type is skipped.

At block 510, process 500 can generate a price, such as price suggestion for the unit type. At block 512, process 500 can compare the generated price to the current price to determine if the current price should be increased or decreased. At block 514, process 500 can select the generated price or the current price based on the threshold difference between the prices. Process 500 can send the generate price, current price, and asset information to a user (e.g., property manager) in a price report.

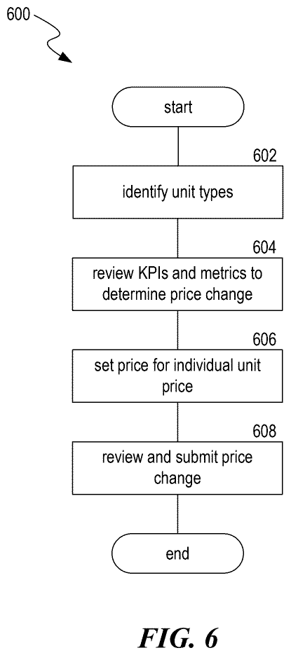

FIG. 6 is a flow diagram illustrating a process used in some implementations for modifying an asking rate in a property revenue management system. In some implementations, process 600 can be initiated by a request to modify a current price for a unit, a user accessing an interface to register property assets, a user requesting revenue information, changes in the status of the property assets, a request for a pricing report, periodically generated pricing report. Thus, process 600 can be device side process or a server-side process for a system that modifies unit asking rates.

The property revenue management system can provide a simple, elegant interface that allows users to quickly and efficiently manage both asking and in-place rates for units. The property revenue management system can automate the process of updating a large number or rates (e.g., hundreds or thousands of rates) which reduces risk for costly errors. The property revenue management system can utilize a simple but powerful ruleset to suggest pricing based on the factors that are important to the company. In certain aspects, an automated tool used to optimize revenue, that users can use to craft formulas and use external data points to generate suggested pricing through machine learning technology and operator specific metrics

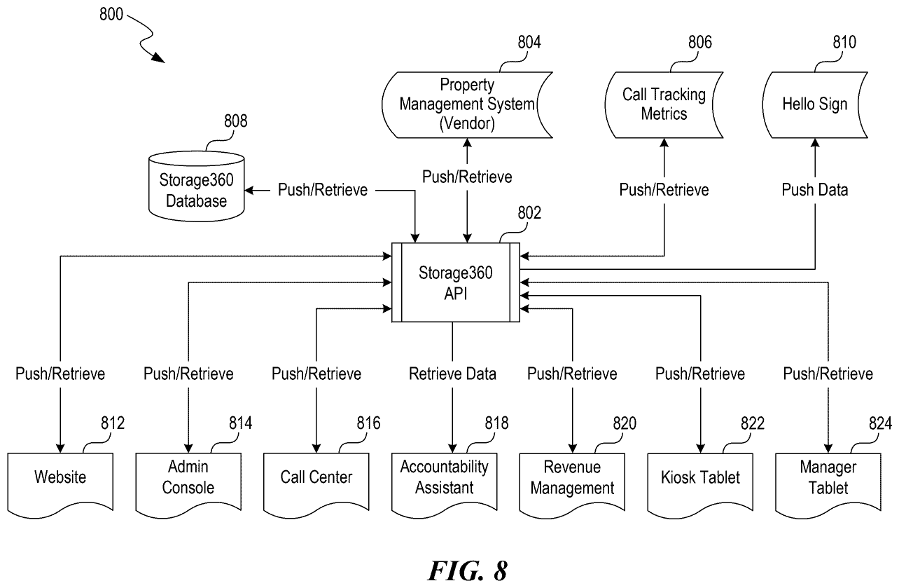

At block 602, process 600 can identify unit types that meet a set of criteria based on filters. Examples of the filters include available units, closing rate, competitor pricing increase or decrease, facility location, current genuine progress indicator (GPI) (e.g., compared to a previous date in time), net rentals, rent rate per square foot, revenue budget vs actual, square foot occupancy percentage, time since last rate increase, time since last rental, time to fill unit, and unique visitors. At block 604, process 600 can review key performance indicators (KPI) and metrics to determine whether the price should increase or decrease, and by what amount. Examples of KPIs/metrics include location code, unit size, unit type, square footage, floor, total units, vacant units, unrentable units, occupancy percentage, move-ins, move-outs, net move-ins, current promotion, standard rate, lowest in-place rate, average in-place rate, maximum in-place rate, days to fill, fill rate, and time since last rental. Statistics that can be seen over a period (e.g., 30-day, 60-day, 90-day, last year, same month or next month time span) can include facility clicks from web searches, facility impressions from web searches, unique facility visitors, facility closing rate, facility move-ins, facility move-outs, facility net move-ins, facility sales calls received by call center agents, unit type move-ins, unit type move-outs, unit type net move-ins, unit type closing rate, unit features, time since last unit type rate change, competitor low price for unit type, competitor average price for unit type, and competitor high price for unit type. At block 606, process 600 can set prices for individual unit types based on the rules (as described in FIG. 5). At block 608, process 600 can review and submit a price change set to be processed into the property management system by the Storage API (such as the Storage 360 API as described in FIG. 8).

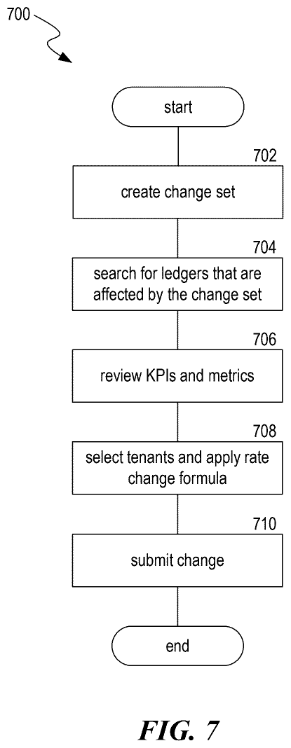

FIG. 7 is a flow diagram illustrating a process used in some implementations for modifying an in-place rate in a property revenue management system. In some implementations, process 700 can be initiated by a request to modify a current price for a unit, a user accessing an interface to register property assets, a user requesting revenue information, changes in the status of the property assets, a request for a pricing report, periodically generated pricing report. Thus, process 700 can be a device side process or a server-side process for a system that modifies unit in-place rates. When modifying the in-place rates, process 700 can focus on tenants who are currently renting with the company. Process 700 can display, on a user interface, search filters and KPIs for in-place rate modifications.

At block 702, process 700 can create a change set and specify the date that the change should be effective. At block 704, process 700 can search for ledgers that are affected by the change set. Examples of the search filters include facility location, days tenant has been at current rate, occupancy percentage, standard dollar rate variance, standard percentage rate variance, unit type, and unit area.

At block 706, process 700 can review KPIs and metrics to determine which ledgers should be affected by the rate change. At block 708, process 700 can select one, some, or all tenants and apply a rate change formula. An example of a rate change formula is: increase by [x] percent, by a minimum of [y] dollars, and a maximum of [z] dollars.

At block 710, process 700 can review and submit the change set for approval. Once approved, the change set is processed into the property management system by the Storage API (such as the Storage 360 API as described in FIG. 8). Examples of pricing formulas include: 1) if 0 units of a type are vacant, move SR to greater of Market Rate High or Actual Rate High; 2) if unit type occupancy is below 80%, and net (such as L30, which refers to the net rentals over the last 30 days where net rental is the difference between rentals and vacancies) is greater than 0, SR moves to Market Average minus some $ or %; 3) if unit type occupancy is below 80%, and net (L30) is less than or equal to 0, SR moves to Market Rate Low plus some $ or %; 4) if unit type occupancy is 80-88.9%, and net (L30) is greater than 0, SR moves to midpoint of market rate average and market rate high; 5) if unit type occupancy is 80-88.9%, and net (L30) is less than 0, SR moves to midpoint of market rate average; 6) if unit type occupancy is greater than or equal to 89%, or fewer than 4 units are vacant, and net (L30) is greater than or equal to 0, move SR to greater of Actual Rate High and Market Rate High; and 7) if unit type occupancy is greater than or equal to 89%, or fewer than 4 units are vacant, and net (L30) is less than 0, move SR to market rate high.

FIG. 8 is a conceptual diagram illustrating an example of a property revenue management system 800. The property revenue management system can be made up of multiple applications and processes that serve a variety of purposes. In some implementations, the Storage360 API 802 is the central hub for the entire property revenue management platform. The Storage360 API 802 can allow various applications and third-party vendor products to communicate with each other. The Storage360 API 802 can allow for data persistence and retrieval operations to be performed against the Storage360 Database 808.

The Storage360 API 802 can interface with the property management system in multiple ways. For example, in a two-way interface (e.g., push and receive), the Storage360 API 802 retrieves and stores information. The Storage360 API 802 can harvest data which is used for various purposes, such as statistical computations, reporting, and oversight. In some implementations, the Storage360 API 802 can send data to the property management system (vendor) 804. The data can include tenant information (e.g., name, physical address, phone number, email address, billing information, etc.), unit information, and ledger information. The Storage360 API 802 can interface with other property management system applications (e.g., property management system 804, call tracking metrics 806, storage360 database 808, hello sign 810, website 812, admin console 814, call center 816, accountability assistant 818, revenue management 820, kiosk tablet 822, and manager tablet 824) to perform real-time financial transactions, create reservations, perform move-ins, schedule move-outs, and update automatic billing preferences.

The Storage360 API 802 can generate multiple reports and send the reports to various distribution lists. These reports provide users with a snapshot of business information without requiring the users to retrieve the information from various systems. The reports can include a call center effective rate report (e.g., tracks various metrics related to daily and month-to-date performance of call center sales agents), a lead conversion report (e.g., provides quick overview of month-to-date lead to tenant conversions), an accounts receivable (A/R) accountability report (e.g., tracks various metrics related to daily & month-to-date accounts receivable (past due) tenant activity), an A/R lead report (e.g., tracks various metrics related to daily & month-to-date lead activity), an operational daily scorecard report (e.g., tracks various metrics across multiple KPIs to give a snapshot of the portfolio accurate to close of previous business day), or an unsigned e-sign document report (e.g., provides a list of unsigned e-Sign documents per facility).

The Storage360 API 802 can have multiple integration points call tracking metrics 806 (e.g., voice over internet protocol (VoIP) service vendor). The call tracking metrics 806 can retrieve all calls made & received for the day and run this data through a matching algorithm to determine which leads & A/R tenants were called. Using this, property revenue management system 800 can provide a contact score to each lead/tenant based on a scale that is customizable by an operations team. The call tracking metrics 806 can broadcast a webhook to the Storage360 API 802 when an agent answers a call in the queue. This webhook contains specific information about the even including which facility was called, which tracking number was called, and which agent answered the call. This information is then used to display a notification on the receiving agent's screen.

The call tracking metrics 806 can perform as an SMS text message delivery service. For example, after a tenant has entered the “past due” status, the tenant will receive text message reminders as well as links to pay their balance online. Tenants can receive an SMS daily or periodically according to schedules, such as day 5 past due, day 7 past due, day 10 past due, day 14 past due, day 18 past due, day 21 past due, day 24 past due, day 28 past due, etc.

The revenue management 820 application can provide a simple, elegant interface that allows users to quickly and efficiently manage both asking and in-place rates. The revenue management 820 application can display aggregate data from multiple sources, sourced by the Storage360 API 802. These KPIs can benefit a business by allowing for quick & confident decision making. The revenue management 820 application also automates the process of updating sometimes hundreds of rates which reduces risk for costly errors. The revenue management 820 application can utilize a simple but powerful ruleset to suggest pricing based on the factors that are most important to the company.

The revenue management 820 application can provide automated pricing suggestions are based on user-defined rules. Additional details on rules and groups are provided herein in relation to FIG. 4. The rules are attached to groups where each group represents a strategy for the facilities that are part of the group. A process runs daily that is responsible for going through each unit type at every facility in a group, determining what the price should be based on the rule definition, and reporting all price suggestions to the revenue management team.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or implementations alternative mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1. A method for automated pricing for storage units, the method comprising:
receiving a group of storage unit types, wherein the storage unit types are grouped together based on one or more group rules;
analyzing each of the storage unit types for each facility in the group of storage unit types;
comparing one or more storage unit type metrics for each of the storage unit types to the one or more rate rules associated with the group of storage unit types; and
in response to a match between the one or more the storage unit type metrics and the one or more rate rules, generating a price for each of the storage unit types.

2. The method of claim 1, further comprising:
determining the one or more rate rules based on a metric, a direction, a logical operator, and an outcome factor.

3. The method of claim 1, further comprising: determining to increase the price of a storage unit type based on one or more key performance indicators and one or more metrics; and
establishing the increased price for the storage unit type.

4. The method of claim 1, further comprising: generating a change set for a storage unit type with a date the change set is executed; determining one or more ledgers affected by the change set based on one or more key performance indicators and one or more metrics; and
applying a rate change formula to one or more tenants of the storage unit type.

5. The method of claim 1, further comprising:
determining to increase or decrease a current price for a storage unit type based on the generated price.

6. The method of claim 1, wherein the one or more storage unit type metrics include available storage unit types, occupancy percentage, and net rentals during a threshold of time.

7. The method of claim 1, wherein the group of storage unit types includes a name, a description, the storage unit types in the group, and the one or more rate rules that are used to determine individual unit type pricing for each group.

8. A computing system for automated pricing for storage units, the computing system comprising:
one or more processors; and
one or more memories storing instructions that, when executed by the one or more processor, cause the computing system to perform a process comprising:
receiving a group of storage unit types, wherein the storage unit types are grouped together based on one or more group rules;
analyzing each of the storage unit types for each facility in the group of storage unit types;
comparing one or more storage unit type metrics for each of the storage unit types to one or more rate rules associated with the group of storage unit types; and
in response to a match between the one or more the storage unit type metrics and the one or more rate rules, generating a price for each of the storage unit types.

9. The computing system of claim 8, wherein the process further comprises:
determining the one or more rate rules based on a metric, a direction, a logical operator, and an outcome factor.

10. The computing system of claim 8, wherein the process further comprises:
determining to increase the price of a storage unit type based on one or more key performance indicators and one or more metrics; and
establishing the increased price for the storage unit type.

11. The computing system of claim 8 wherein the process further comprises:
generating a change set for a storage unit type with a date the change set is executed;
determining one or more ledgers affected by the change set based on one or more key performance indicators and one or more metrics; and
applying a rate change formula to one or more tenants of the storage unit type.

12. The computing system of claim 88, wherein the process further comprises:
determining to increase or decrease a current price for a storage unit type based on the generated price.

13. The computing system of claim 8, wherein the one or more storage unit type metrics include available storage unit types, occupancy percentage, and net rentals during a threshold of time.

14. The computing system of claim 8, wherein the group of storage unit types includes a name, a description, the storage unit types in the group, and the one or more rate rules that are used to determine individual unit type pricing for each group.

15. A machine-readable storage medium having machine executable instructions stored thereon that, when executed by one or more processors, direct the one or more processors to perform a method for automated pricing for storage units, the method comprising:
receiving a group of storage unit types, wherein the storage unit types are grouped together based on one or more group rules;
analyzing each of the storage unit types for each facility in the group of storage unit types;
comparing one or more storage unit type metrics for each of the storage unit types to the one or more rate rules associated with the group of storage unit types; and
in response to a match between the one or more the storage unit type metrics and the one or more rate rules, generating a price for each of the storage unit types.

16. The machine-readable storage medium of claim 15, wherein the method further comprises:
determining the one or more rules based on a metric, a direction, a logical operator, and an outcome factor.

17. The machine-readable storage medium claim 15, wherein the method further comprises:
determining to increase the price of a storage unit type based on one or more key performance indicators and one or more metrics; and
establishing the increased price for the storage unit type.

18. The machine-readable storage medium of claim 15, wherein the method further comprises:
generating a change set for a storage unit type with a date the change set is executed;
determining one or more ledgers affected by the change set based on one or more key performance indicators and one or more metrics; and
applying a rate change formula to one or more tenants of the storage unit type.

19. The machine-readable storage medium of claim 15, wherein the one or more storage unit type metrics include available storage unit types, occupancy percentage, and net rentals during a threshold of time.

20. The machine-readable storage medium of claim 15, wherein the group of storage unit types includes a name, a description, the storage unit types in the group, and the one or more rules that are used to determine individual unit type pricing for each group.
